(19) United States
(12) Patent Application Publication
(10) Pub. No.: US 2024/0001163 A1
(43) Pub. Date: Jan. 4, 2024

(54) SYSTEM AND METHOD OF EFFICIENT COUPLING OF AN AIR BOTTLE TO AN EMERGENCY AIR FILL STATION WITHIN A SAFETY SYSTEM OF A STRUCTURE

(71) Applicant: Anthony J. Turiello, Westlake, TX (US)

(72) Inventor: Anthony J. Turiello, Westlake, TX (US)

(21) Appl. No.: 18/211,597

(22) Filed: Jun. 20, 2023

Related U.S. Application Data
(60) Provisional application No. 63/357,155, filed on Jun. 30, 2022.
(60) Provisional application No. 63/356,996, filed on Jun. 29, 2022.

(51) Int. Cl. A62B 9/04

(52) U.S. Cl. CPC A62B 9/04

(57) ABSTRACT

An emergency air replenishment system includes an emergency air fill station coupled to a fixed piping system associated with a source of replenishment of breathable air, and an air bottle. The emergency air fill station includes a first connector that is connectably complementary to a second connector of the air bottle. The first connector is couplable to the second connector based on insertion of the second connector thereinto automatically exerting a force along an axial length thereof that automatically translates into a locking element girdling the first connector moving against a linear direction of the exerted force to lock on to the second connector. A volume of the breathable air in the air bottle is filled from the fixed piping system via the emergency air fill station based on the locking of the first connector to the second connector.

### CLAIM OF PRIORITY

This application is a conversion application of, and claims priority to, U.S. Provisional Patent Application No. 63/357,155 titled EFFICIENT COUPLING OF AN AIR BOTTLE TO AN EMERGENCY AIR FILL STATION WITHIN A SAFETY SYSTEM OF A STRUCTURE filed on Jun. 30, 2022 and U.S. Provisional Patent Application No. 63/356,996 titled CLOUD-BASED FIREFIGHTING AIR REPLENISHMENT MONITORING SYSTEM, SENSORS AND METHODS filed on Jun. 29, 2022. The contents of each of the aforementioned applications are incorporated herein by reference in entirety thereof.

### FIELD OF TECHNOLOGY

This disclosure relates generally to emergency systems and, more particularly, to an apparatus, system and/or a method of efficient coupling of an air bottle to an emergency air fill station within a safety system of a structure.

### BACKGROUND

A structure (e.g., a vertical building, a horizontal building, a tunnel, marine craft) may have a Firefighter Air Replenishment System (FARS) implemented therein. The FARS may have an emergency air fill station therein to enable firefighters and/or emergency personnel inhale safe air through face-pieces of respirators or Self-Contained Breathing Apparatuses (SCBAs) thereof that have connectors couplable to complementary connectors on fill hoses of the emergency air fill station. However, the firefighters may not be able to refill air bottles (e.g., breathing air cylinders) thereof that could also be used to supply breathable air thereto through the face-pieces or the SCBAs.

### SUMMARY

Disclosed are systems and/or a method of efficient coupling of an air bottle to an emergency air fill station within a safety system of a structure.

In one aspect, an emergency air replenishment system implemented in a structure includes a fixed piping system permanently installed within the structure serving as a constant source of replenishment of breathable air, and an emergency air fill station within the structure coupled to the fixed piping system. The emergency air fill station further includes a first connector as a part thereof that is connectably complementary to a second connector directly attached to an air bottle. The first connector is couplable to the second connector upon insertion of the first connector or the second connector into the other second connector or the first connector to cause the first connector and the second connector to be locked to one another based on the insertion of the first connector or the second connector into the other second connector or the first connector automatically exerting a force along an axial length of the other second connector or the first connector that automatically translates into a locking element girdling the other second connector or the first connector moving against a linear direction of the exerted force to lock on to the first connector or the second connector. A volume of the breathable air in the air bottle is filled from the fixed piping system via the emergency air fill station based on the locking of the first connector to the second connector.

In another aspect, an emergency air replenishment system implemented in a structure includes an emergency air fill station within the structure coupled to a fixed piping system permanently installed therewithin serving as a constant source of replenishment of breathable air, with the emergency air fill station further including a first connector as a part thereof, and an air bottle including a second connector directly attached thereto. The first connector of the emergency air fill station is connectably complementary to the second connector directly attached to the air bottle. The first connector is couplable to the second connector upon insertion of the first connector or the second connector into the other second connector or the first connector to cause the first connector and the second connector to be locked to one another based on the insertion of the first connector or the second connector into the other second connector or the first connector automatically exerting a force along an axial length of the other second connector or the first connector that automatically translates into a locking element girdling the other second connector or the first connector moving against a linear direction of the exerted force to lock on to the first connector or the second connector. A volume of the breathable air in the air bottle is filled from the fixed piping system via the emergency air fill station based on the locking of the first connector to the second connector.

In yet another aspect, a method of efficient coupling of an air bottle to an emergency air fill station of a safety system of a structure having a fixed piping system installed therein to supply breathable air from a source across the safety system is disclosed. The method includes providing a first connector as part of the emergency air fill station such that the first connector is connectably complementary to a second connector directly attached to the air bottle. The method also includes locking the first connector and the second connector to one another based on coupling the first connector to the second connector upon insertion of the first connector or the second connector into the corresponding second connector or the first connector in accordance with the insertion of the first connector or the second connector into the corresponding second connector or the first connector automatically exerting a force along an axial length of the corresponding second connector or the first connector that automatically translates into a locking element girdling the corresponding second connector or the first connector moving against a linear direction of the exerted force to lock on to the first connector or the second connector. Further, the method includes filling a volume of the breathable air in the air bottle via the emergency air fill station based on the locking of the first connector to the second connector.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a safety system associated with a structure, according to one or more embodiments.

FIG. 2 is a schematic view of an emergency air fill panel as an example emergency air fill station of the safety system of FIG. 1, according to one or more embodiments.

FIG. 3 is a schematic view of a rupture containment air fill station as another example emergency air fill station of the safety system of FIG. 1, according to one or more embodiments.

FIG. 4 is a schematic view of a connector provided on the emergency air fill panel of FIG. 2 and the rupture containment air fill station of FIG. 3, with the connector configured to connect to another connector provided on an air bottle based on a quick attachment mechanism, according to one or more embodiments.

FIG. 5 is a schematic view of a connected state of the connector and the another connector of FIG. 4, according to one or more embodiments.

FIG. 6 is a process flow diagram detailing the operations involved in efficient coupling an air bottle to an emergency air fill station within a safety system of a structure, according to one or more embodiments.

Other features of the present embodiments will be apparent from the accompanying drawings and from the detailed description that follows.

### DETAILED DESCRIPTION

Example embodiments, as described below, may be used to provide systems and/or a method of efficient coupling of an air bottle to an emergency air fill station within a safety system of a structure. Although the present embodiments have been described with reference to specific example embodiments, it will be evident that various modifications and changes may be made to these embodiments without departing from the broader spirit and scope of the various embodiments.

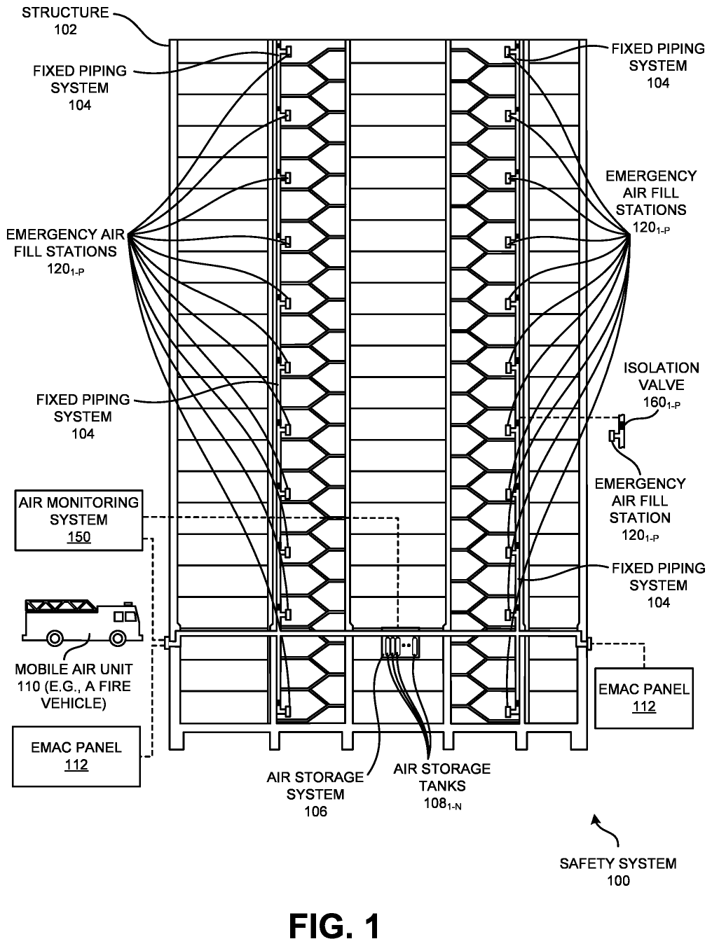

FIG. 1 shows a safety system 100 associated with a structure 102, according to one or more embodiments. In one or more embodiments, safety system 100 may be a Firefighter Air Replenishment System (FARS) to enable firefighters entering structure 102 in times of fire-related emergencies to gain access to breathable (e.g., human breathable) air in-house without the need of bringing in air bottles (e.g., breathing air cylinders) to be transported up several flights of stairs of structure 102 or deep thereinto. In one or more embodiments, safety system 100 may supply air provided from a supply of air tanks (to be discussed) stored in structure 102. When a fire department vehicle arrives at structure 102 during an emergency, air supply typically may be provided through a source of air connected to said vehicle. In one or more embodiments, safety system 100 may enable firefighters to refill air bottles thereof at emergency air fill stations (to be discussed) located throughout structure 102. Specifically, in some embodiments, firefighters may be able to fill air bottles/cylinders thereof at emergency air fill stations within structure 102 under full respiration in less than one to two minutes.

In one or more embodiments, structure 102 may encompass vertical building structures, horizontal building structures (e.g., shopping malls, hypermarts, extended shopping, storage and/or warehousing related structures), tunnels and marine craft (e.g., large marine vessels such as cruise ships, cargo ships, submarines and large naval craft, which may be “floating” versions of buildings and horizontal structures). In one or more embodiments, safety system 100 may include a fixed piping system 104 permanently installed within structure 102 serving as a constant source of replenishment of breathable air. Fixed piping system 104 may be regarded as being analogous to a water piping system within structure 102 or another structure analogous thereto for the sake of imaginative convenience.

As shown in FIG. 1, fixed piping system 104 may distribute/supply air across floors/levels of structure 102 and, generally, across structure 102/safety system 100. For the aforementioned purpose, fixed piping system 104 may distribute air from an air storage system 106 (e.g., within structure 102) including a number of air storage tanks 108_{1-N} that serve as sources of pressurized air. Additionally, in one or more embodiments, fixed piping system 104 may interconnect with a mobile air unit 110 (e.g., a fire vehicle) through an External Mobile Air Connection (EMAC) panel 112.

In one or more embodiments, EMAC panel 112 may be a boxed structure (e.g., exterior to structure 102) to enable the interconnection between mobile air unit 110 and safety system 100. For example, mobile air unit 110 may include an on-board air compressor to store and replenish pressurized/compressed air in air bottles/cylinders (e.g., utilizable with Self-Contained Breathing Apparatuses (SCBAs) carried by firefighters). Mobile air unit 110 may also include other pieces of air supply/distribution equipment (e.g., piping and/or air cylinders/bottles) that may be able to leverage the sources of breathable air within safety system 100 through EMAC panel 112. Firefighters, for example, may be able to fill air into air bottles/cylinders (e.g., spare bottles, bottles requiring replenishment of breathable air) carried on mobile air unit 110 through safety system 100.

In FIG. 1, EMAC panel 112 is shown at two locations merely for the sake of illustrative convenience. In one or more embodiments, an air monitoring system 150 may be installed as part of safety system 100 to automatically track and monitor a parameter (e.g., pressure) and/or a quality (e.g., indicated by moisture levels, carbon monoxide levels) of breathable air within safety system 100. FIG. 1 shows air monitoring system 150 as communicatively coupled to air storage system 106 and EMAC panel 112 merely for the sake of example. It should be noted that EMAC panel 112 may be at a remote location associated with (e.g., internal to, external to) structure 102. In one or more embodiments, for monitoring the parameters and/or the quality of breathable air within safety system 100, air monitoring system 150 include appropriate sensors and circuitries therein. For example, a pressure sensor (not shown) within air monitoring system 150 may automatically sense and record the pressure of the breathable air of safety system 100. Said pressure sensor may communicate with an alarm system that is triggered when the sensed pressure is outside a safety range. Also, in one or more embodiments, air monitoring system 150 may automatically trigger a shutdown of breathable air distribution through safety system 100 in case of impurity/contaminant (e.g., carbon monoxide) detection therethrough yielding levels above a safety threshold.

In one or more embodiments, fixed piping system 104 may include pipes (e.g., constituted out of stainless steel tubing) that distribute breathable air to a number of emergency air fill stations 120_{1-P} within structure 102. In one example implementation, each emergency air fill station 120_{1-P} may be located at a specific level of structure 102. If structure 102 is regarded as a vertical building structure, an emergency air fill station 120_{1-P} may be located at each of a basement level, a first floor level, a second floor level and so on. For example, emergency air fill station 120_{1-P} may be located at the end of the flight of stairs that emergency fighting personnel (e.g., firefighting personnel) need to climb to reach a specific floor level within the vertical building structure.

In one or more embodiments, an emergency air fill station 120_{1-P} may be a static location within a level of structure 102 that provides emergency personnel (e.g., firefighters) with the ability to rapidly fill air bottles/cylinders (e.g., SCBA cylinders). In one or more embodiments, emergency air fill station 120_{1-P} may be an emergency air fill panel or a rupture containment air fill station. In one or more embodiments, proximate each emergency air fill station 120_{1-P}, safety system 100 may include an isolation valve 160_{1-P} to isolate a corresponding emergency air fill station 120_{1-P} from a rest of safety system 100. For example, said isolation may be achieved through the manual turning of isolation valve 160_{1-P} proximate the corresponding emergency air fill station 120_{1-P} or remotely from air monitoring system 150. In one example implementation, air monitoring system 150 may maintain breathable air supply to a subset of emergency air fill stations 120_{1-P} through control of a corresponding subset of isolation valves 160_{1-P} and may isolate the other emergency air fill stations 120_{1-P} from the breathable air supply. It should be noted that configurations and components of safety system 100 may vary from the example safety system 100 of FIG. 1.

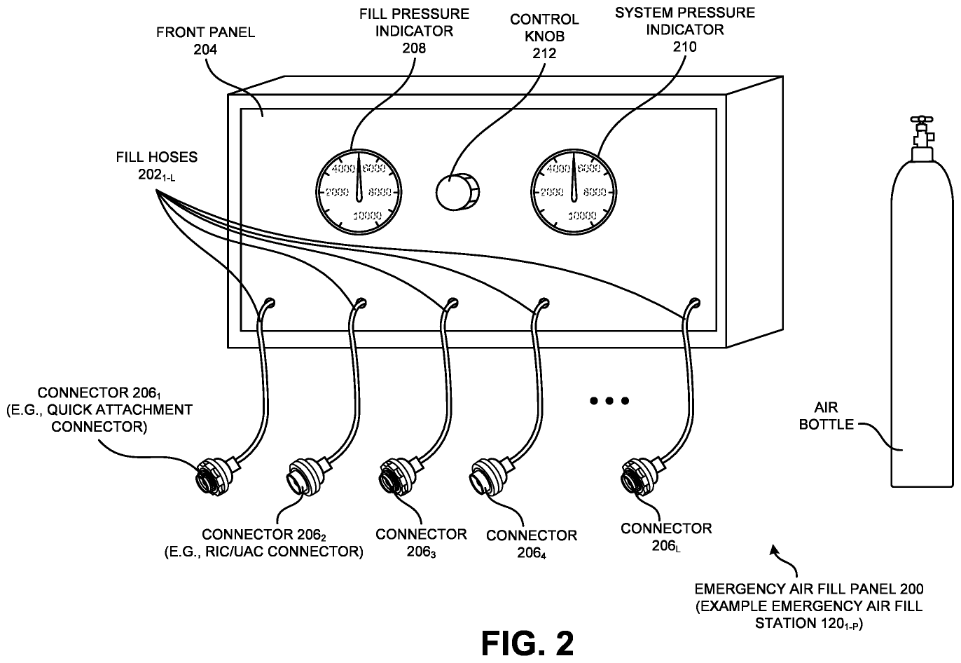

FIG. 2 shows an emergency air fill panel 200 as an example emergency air fill station 120_{1-P}, according to one or more embodiments. In one or more embodiments, emergency air fill panel 200 may enable firefighters/emergency personnel to rapidly fill air bottles/cylinders thereof through the use of connectors (to be discussed). In one or more embodiments, a number of fill hoses 202_{1-L} may protrude from a front panel 204 of emergency air fill panel 200; each of said fill hoses 202_{1-L} may have a connector 206_{1-L} at an end (e.g., free end) thereof not attached to front panel 204. In one or more embodiments, one fill hose 202_{1-L} may have a connector 206_{1-L} at a free end thereof different from a corresponding connector of another fill hose 202_{1-L}. For example, one fill hose 202_{1-L} may have a Rapid Intervention Crew Universal Air Coupling (RIC/UAC) connector as connector 206_{1-L} at the free end thereof and another fill hose 202_{1-L} may have a quick attachment connector as connector 206_{1-L} at the free end thereof. Exemplary embodiments discussed herein provide for the first quick attachment connector elements on emergency air fill stations 120_{1-P} (e.g., emergency air fill panel 200, rupture containment air fill station 300) that are complementary to other quick attachment connector elements provided on top of air bottles/cylinders.

In one or more embodiments, emergency air fill panel 200 may be directly coupled (e.g., connected) to air bottles/cylinders by way of connector 206_{1-L}, as will be discussed below. In one or more embodiments, emergency air fill panel 200 may also include a fill pressure indicator 208 (e.g., a pressure gauge) to indicate a pressure (e.g., a standard pressure) to which an air bottle/cylinder may be filled, a system pressure indicator 210 to indicate a current pressure level of breathable air in safety system 100, and a control knob 212 to adjust the pressure to which the air bottle/cylinder may be filled such that said pressure does not exist a safety threshold thereof (e.g., the safety threshold that safety system 100 may be designed for).

In one or more embodiments, connecting emergency air fill panel to air bottles/cylinders through fill hoses 202_{1-L} thereof may enable precious time to be saved on behalf of the firefighters/emergency personnel who, without capabilities therefor, need to remove emergency equipment from rescue attires thereof before being supplied with breathable air. Typically, connectors (e.g., RIC/UAC based) on face-pieces of respirators or SCBAs may couple to complementary connectors on fill hoses of emergency air fill panels. Exemplary embodiments, as discussed above, may facilitate the first direct connection between emergency air fill panel 200 and air bottles/cylinders based on quick attachment connectors by way of fill hoses 202_{1-L}.

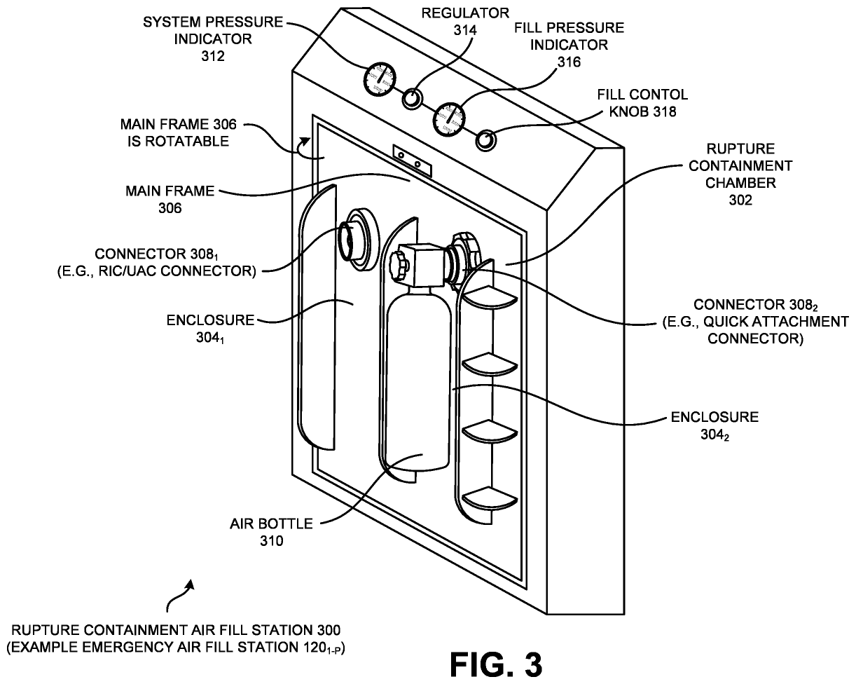

FIG. 3 shows a rupture containment air fill station 300 as another example emergency air fill station 120_{1-P}, according to one or more embodiments. In one or more embodiments, rupture containment air fill station 300 may constitute a rupture containment chamber that facilitates shielding of over-pressurized air cylinders/bottles and containment thereof within the rupture containment chamber to prevent injuries due to bursts/ruptures thereof. As seen in FIG. 3, in one or more embodiments, rupture containment air fill station 300 may include a rupture containment chamber 302 with specific enclosures 304₁₋₂ for accommodating air cylinders/bottles therewithin. In one or more embodiments, each enclosure 304₁₋₂ may provide space to accommodate an air cylinder/bottle therewith by way of the air cylinder/bottle being connected to rupture containment air fill station 300.

In one or more embodiments, rupture containment chamber 302 may have a main frame 306 thereof that includes a connector 308₁₋₂ (e.g., analogous to connectors 206_{1-L}) provided within or proximate each enclosure 304₁₋₂. FIG. 3 shows an air bottle 310 within an enclosure 304₁₋₂ for the sake of illustration. In one or more embodiments, as will be seen, air bottle 310 may include another connector (to be discussed) attached to a top thereof that is complementary to connector 308₁₋₂. In one or more embodiments, air bottle 310 may thus be connected to rupture containment chamber 302 directly by way of connector 308₁₋₂ to enable replenishment of breathable air therein. In one or more embodiments, main frame 306 may be rotatable such that, upon rotation, main frame 306 with air bottle 310 within an enclosure 304₁₋₂ may be isolated from an external environment of rupture containment air fill station 300. In one or more embodiments, in this state of isolation, air bottle 310 may not be visible or not face the emergency personnel/firefighters in front of rupture containment air fill station 300.

In one or more embodiments, as seen in FIG. 3, rupture containment air fill station 300 may include a system pressure indicator 312 (e.g., analogous to system pressure indicator 210) indicating the pressure level at which breathable air is being delivered through safety system 100, a regulator 314 to adjust the pressure of the source of the compressed breathable air to ensure that said pressure may not exceed a design pressure of safety system 100, a fill pressure indicator 316 (e.g., analogous to fill pressure indicator 208) to indicate a pressure (e.g., a standard pressure) to which air bottle 310 may be filled, and a fill control knob 318 (e.g., analogous to control knob 212) to control the pressure to which air bottle 310 may be filled such that said pressure does not exceed a safety threshold thereof within safety system 100.

It should be noted that FIG. 3 merely shows two enclosures 304₁₋₂ and two connectors 308₁₋₂ for the sake of illustrative convenience and that any number of enclosures and connectors are within the scope of the exemplary embodiments discussed herein. The same thing may also apply to FIG. 2 and the number of fill hoses 202_{1-L} and connectors 206_{1-L} in emergency air fill panel 200. Also, it should be noted that the components of emergency air fill panel 200 and rupture containment air fill station 300, and layouts, distribution and the numbers thereof may vary. FIGS. 2 and 3 merely illustrate an example emergency air fill panel 200 and a rupture containment air fill station 300 respectively.

Further, it should be noted that connectors 206_{1-L} and/or connectors 308₁₋₂ may all be of the same kind (e.g., quick attachment based (to be discussed below), RIC/UAC based). Alternately, in one or more embodiments, connectors 206_{1-L} of FIG. 2 may have multiple kinds thereof provided on emergency air fill panel 200; similarly, connectors 308₁₋₂ may each be of a different kind from the other. For example, one or more connectors 206_{1-L}/308₁₋₂ may be quick attachment based and one or more other of connectors 206_{1-L}/308₁₋₂ may be RIC/UAC based. All reasonable variations are within the scope of the exemplary embodiments discussed herein.

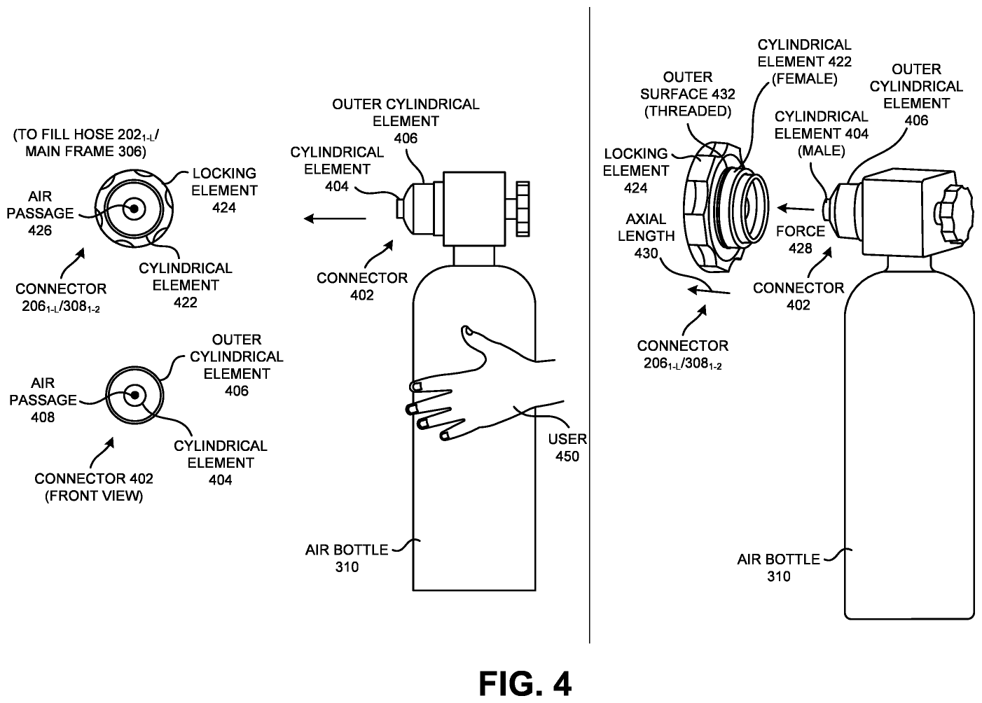

FIG. 4 shows a connector 206_{1-L}/308₁₋₂ provided on emergency air fill panel 200/rupture containment air fill station 300 configured to connect to a connector 402 provided on air bottle 310 based on a quick attachment mechanism, according to one or more embodiments. In one or more embodiments, air bottle 310 may be made of aluminium, steel and/or a composite material (e.g., carbon fiber wrapped). In the case of a composite material based air bottle 310, rupture containment air fill station 300 may not be utilized. As seen in FIG. 4, in one or more embodiments, connector 206_{1-L}/308₁₋₂ may be connectably complementary to connector 402 directly attached to air bottle 310. In one example implementation, connector 206_{1-L} at a free end of a fill hose 202_{1-L} or connector 308₁₋₂ provided directly on main frame 306 of rupture containment chamber 302 of rupture containment air fill station 300 may constitute a “female” element of the connection and connector 402 provided on air bottle 310 may constitute a “male” element thereof. It should be noted that the reversal of “female”/“male” roles by connector 206_{1-L}/connector 308₁₋₂ and connector 402 is within the scope of the exemplary embodiments discussed herein.

FIG. 4 shows connector 402 prior to the connection thereof to connector 206_{1-L}/connector 308₁₋₂, according to one or more embodiments. In one or more embodiments, connector 402 provided directly on top (e.g., around a mouth of air bottle 310) of air bottle 310 may include a cylindrical element 404 protruding in a direction lateral to a length of air bottle 310. In some embodiments, said cylindrical element 404 may be protected by an outer cylindrical element 406; cylindrical element 404 may protrude slightly out of outer cylindrical element 406.

In one or more embodiments, connector 206_{1-L}/308₁₋₂ may include a cylindrical element 422 wider (e.g., in diameter) than cylindrical element 404 of connector 402. In one or more embodiments, the couplable elements of connector 206_{1-L}/308₁₋₂ and connector 402 (e.g., outer covering may be made of a different material or a hybrid material) may all be made of stainless steel, brass and/or aluminium. In one or more embodiments, connector 206_{1-L}/308₁₋₂ may have a locking element 424 girdling cylindrical element 422 thereof; cylindrical element 422 of connector 206_{1-L}/308₁₋₂ and cylindrical element 404 (and outer cylindrical element 406) of connector 402 may instead be regarded as connector 206_{1-L}/308₁₋₂ and connector 402 respectively and locking element 424 may be regarded as girdling connector 402. It should be noted that, in some embodiments, locking element 424 may not be part of connector 206_{1-L}/308₁₋₂ and may be considered as external thereto.

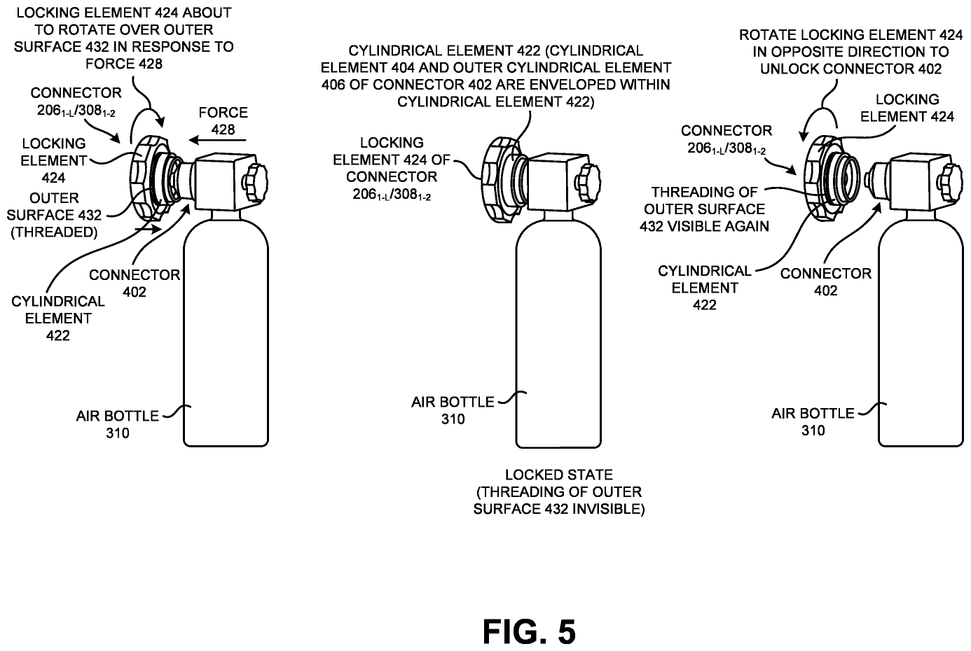

In one or more embodiments, each of cylindrical element 404 of connector 402 and cylindrical element 422 of connector 206_{1-L}/308₁₋₂ may be provided with an air passage (e.g., air passage 408 of connector 402 and air passage 426 of connector 206_{1-L}/308₁₋₂) to maintain an air connection between air bottle 310 and emergency air fill station 120_{1-P} (e.g., emergency air fill panel 200, rupture containment air fill station 300) in a connected state thereof. FIG. 5 shows a connected state of connector 402 with connector 206_{1-L} in the case of an emergency air fill panel 200 and connector 402 to connector 308₁₋₂ in the case of rupture containment air fill station 300, according to one or more embodiments.

As indicated in FIG. 4, a user 450 (e.g., a firefighter, emergency personnel) may hold air bottle 310 to insert cylindrical element 404 (and outer cylindrical element 406) of connector 402 on air bottle 310 into cylindrical element 422 of connector 206_{1-L}/connector 308₁₋₂. In one or more embodiments, in accordance with the insertion, cylindrical element 404 (and outer cylindrical element 406) may be received within cylindrical element 422, thereby causing cylindrical element 404 to press into cylindrical element 422. In one or more embodiments, the pressing may automatically exert a force 428 along an axial length 430 of cylindrical element 422/connector 206_{1-L}/308₁₋₂. As shown in FIG. 4, in one or more embodiments, an outer surface 432 of cylindrical element 422 may be threaded and locking element 424 may girdle said outer surface 432. However, in one or more embodiments, the exertion of force 428 may automatically translate into locking element 424 moving against a linear direction of the exerted force 428 across the threaded outer surface 432. In other words, in one or more embodiments, locking element 424 may automatically rotate quickly (e.g., rotational motion plus translational motion) across the threaded outer surface 432 in a direction opposite to that of the exerted force 428. In one or more embodiments, over the course of the automatic quick rotation, locking element 424 may cross the threaded outer surface 432 to lock on to connector 402. In one or more embodiments, the aforementioned state may be the state in which connector 402 and connector 206_{1-L}/connector 308₁₋₂ may be locked on to one another, thereby implying that air bottle 310 is locked on to emergency air fill station 120_{1-P}. As seen in FIG. 5, in this locked state, the threaded outer surface 432 may not be visible to user 450.

In one or more embodiments, based on air passage 408 of connector 402 and air passage 426 of connector 206_{1-L}/308₁₋₂ forming a stable air connection in the connected state of air bottle 310 and emergency air fill station 120_{1-P}, air bottle 310 may be replenished with breathable air from safety system 100 by way of fixed piping system 104. In one or more embodiments, user 450 may rotate/turn locking element 424 around cylindrical element 404 counter to the previously discussed (rotation) direction of the automatic rotational movement of locking element 424 to unlock air bottle 310 from emergency air fill station 120_{1-P} such that air bottle 310 with connector 402 is removable (e.g., releasable) from connector 206_{1-L}/308₁₋₂ of emergency air fill station 120_{1-P}.

Thus, exemplary embodiments provide for a quick attachment of air bottle 310 with emergency air fill station 120_{1-P} based on provision of connectors 206_{1-L}/308₁₋₂ on emergency air fill stations 120_{1-P}. In one or more embodiments, a rapid and complete refilling of air bottle 310 may be accomplished in a minute or a minute and a half or less based on the quick attachment mechanism for a range of fill pressures. All reasonable variations are within the scope of the exemplary embodiments discussed herein.

It should be noted that, while exemplary embodiments have been discussed with regard to firefighters/emergency personnel connecting air bottles 310 to emergency air fill stations 120_{1-P}, user 450 discussed herein may also encompass personnel associated with training sessions, test sessions and/or periodic status check sessions.

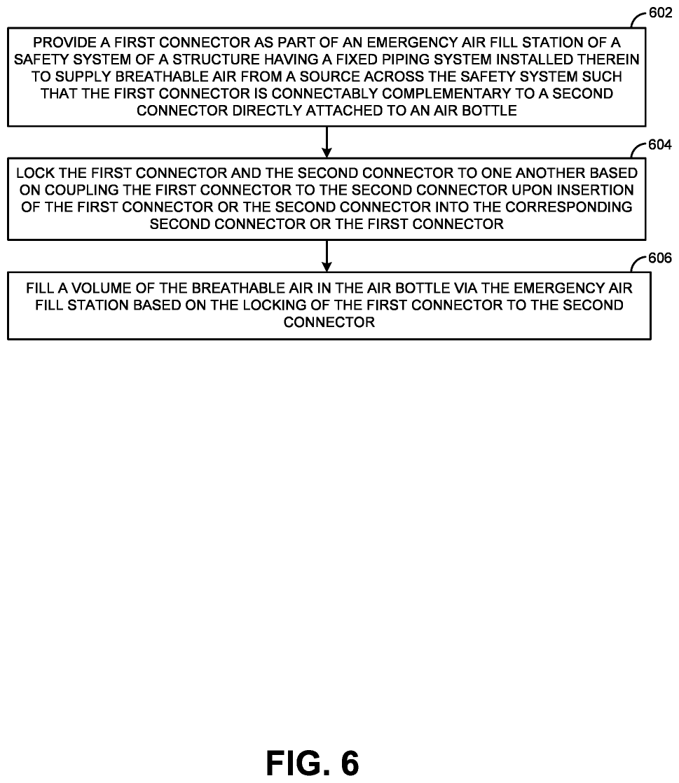

FIG. 6 shows a process flow diagram detailing the operations involved in efficient coupling an air bottle (e.g., air bottle 310) to an emergency air fill station (e.g., emergency air fill station 120_{1-P}) within a safety system (e.g., safety system 100) of a structure (e.g., structure 102), according to one or more embodiments. In one or more embodiments, the safety system of the structure may include a fixed piping system (e.g., fixed piping system 104) implemented therein to supply breathable air across the safety system. In one or more embodiments, operation 602 may involve providing a first connector (e.g., connector 206_{1-L}/connector 308₁₋₂) as part of the emergency air fill station within the structure such that the first connector is connectably complementary to a second connector (e.g., connector 402) directly attached to the air bottle.

In one or more embodiments, operation 604 may involve locking (e.g., instantly) the first connector and the second connector to one another based on coupling the first connector to the second connector upon insertion of the second connector into the first connector in accordance with the insertion of the second connector into the first connector automatically exerting a force (e.g., force 428) along an axial length (e.g., axial length 430) of the first connector that automatically translates into a locking element (e.g., locking element 424) girdling the first connector moving against a linear direction of the exerted force to lock on to the second connector. In one or more embodiments, operation 606 may then involve filling a volume of the breathable air in the air bottle via the emergency air fill station based on the locking of the first connector to the second connector.

Again, it should be noted that the configurations discussed with regard to FIG. 6 in terms of the first connector and the second connector may be reversed as indicated in FIG. 6.

Although the present embodiments have been described with reference to specific example embodiments, it will be evident that various modifications and changes may be made to these embodiments without departing from the broader spirit and scope of the various embodiments.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. An emergency air replenishment system implemented in a structure, comprising:
a fixed piping system permanently installed within the structure serving as a constant source of replenishment of breathable air; and
an emergency air fill station within the structure coupled to the fixed piping system, the emergency air fill station further comprising a first connector as a part thereof that is connectably complementary to a second connector directly attached to an air bottle,
wherein the first connector is couplable to the second connector upon insertion of one of: the first connector and the second connector into a corresponding other of: the first connector and the second connector to cause the first connector and the second connector to be locked to one another based on:
the insertion of the one of: the first connector and the second connector into the corresponding other of: the first connector and the second connector automatically exerting a force along an axial length of the corresponding other of: the first connector and the second connector that automatically translates into a locking element girdling the corresponding other of: the first connector and the second connector moving against a linear direction of the exerted force to lock on to the one of: the first connector and the second connector, and
wherein a volume of the breathable air in the air bottle is filled from the fixed piping system via the emergency air fill station based on the locking of the first connector to the second connector.

2. The emergency air replenishment system of claim 1, wherein an outer surface of the corresponding other of: the first connector and the second connector is threaded to facilitate an automatic rotational movement of the locking element along the threaded outer surface and against the linear direction of the exerted force in response thereto to lock on to the one of: the first connector and the second connector.

3. The emergency air replenishment system of claim 1, wherein the emergency air fill station is at least one of: an emergency air fill panel and a rupture containment air fill station configured to contain the air bottle within an enclosure.

4. The emergency air replenishment system of claim 1, wherein the emergency air fill station further comprises a Rapid Intervention Crew Universal Air Coupling (RIC/UAC) connector also as another part of the emergency air fill station within the structure in addition to the first connector.

5. The emergency air replenishment system of claim 3, wherein the first connector is provided directly at least one of: at a free end of a fill hose of the emergency air fill panel and on a main frame of the rupture containment air fill station.

6. The emergency air replenishment system of claim 1, wherein each of: the first connector and the second connector comprises an air passage to maintain an air connection between the air bottle and the emergency air fill station in a state of the first connector being locked to the second connector.

7. The emergency air replenishment system of claim 2, wherein turning the locking element counter to a rotational direction of the automatic rotational movement thereof unlocks the air bottle from the emergency air fill station such that the air bottle with the second connector is removable from the first connector of the emergency air fill station.

8. An emergency air replenishment system implemented in a structure, comprising:
an emergency air fill station within the structure coupled to a fixed piping system permanently installed therewithin serving as a constant source of replenishment of breathable air, the emergency air fill station further comprising a first connector as a part thereof; and
an air bottle comprising a second connector directly attached thereto,
wherein the first connector of the emergency air fill station is connectably complementary to the second connector directly attached to the air bottle,
wherein the first connector is couplable to the second connector upon insertion of one of: the first connector and the second connector into a corresponding other of: the first connector and the second connector to cause the first connector and the second connector to be locked to one another based on:
the insertion of the one of: the first connector and the second connector into the corresponding other of: the first connector and the second connector automatically exerting a force along an axial length of the corresponding other of: the first connector and the second connector that automatically translates into a locking element girdling the corresponding other of: the first connector and the second connector moving against a linear direction of the exerted force to lock on to the one of: the first connector and the second connector, and
wherein a volume of the breathable air in the air bottle is filled from the fixed piping system via the emergency air fill station based on the locking of the first connector to the second connector.

9. The emergency air replenishment system of claim 8, wherein an outer surface of the corresponding other of: the first connector and the second connector is threaded to facilitate an automatic rotational movement of the locking element along the threaded outer surface and against the linear direction of the exerted force in response thereto to lock on to the one of: the first connector and the second connector.

10. The emergency air replenishment system of claim 9, wherein turning the locking element counter to a rotational direction of the automatic rotational movement thereof unlocks the air bottle from the emergency air fill station such that the air bottle with the second connector is removable from the first connector of the emergency air fill station.

11. The emergency air replenishment system of claim 8, wherein the emergency air fill station is at least one of: an emergency air fill panel and a rupture containment air fill station configured to contain the air bottle within an enclosure.

12. The emergency air replenishment system of claim 8, wherein the emergency air fill station further comprises a RIC/UAC connector also as another part of the emergency air fill station within the structure in addition to the first connector.

13. The emergency air replenishment system of claim 11, wherein the first connector is provided directly at least one of: at a free end of a fill hose of the emergency air fill panel and on a main frame of the rupture containment air fill station.

14. The emergency air replenishment system of claim 8, wherein each of: the first connector and the second connector comprises an air passage to maintain an air connection between the air bottle and the emergency air fill station in a state of the first connector being locked to the second connector.

15. A method of efficient coupling of an air bottle to an emergency air fill station of a safety system of a structure having a fixed piping system installed therein to supply breathable air from a source across the safety system, comprising:
providing a first connector as part of the emergency air fill station such that the first connector is connectably complementary to a second connector directly attached to the air bottle;
locking the first connector and the second connector to one another based on coupling the first connector to the second connector upon insertion of one of: the first connector and the second connector into a corresponding other of: the first connector and the second connector in accordance with:
the insertion of the one of: the first connector and the second connector into the corresponding other of: the first connector and the second connector automatically exerting a force along an axial length of the corresponding other of: the first connector and the second connector that automatically translates into a locking element girdling the corresponding other of: the first connector and the second connector moving against a linear direction of the exerted force to lock on to the one of: the first connector and the second connector; and
filling a volume of the breathable air in the air bottle via the emergency air fill station based on the locking of the first connector to the second connector.

16. The method of claim 15, further comprising additionally providing a RIC/UAC connector also as another part of the emergency air fill station.

17. The method of claim 15, further comprising threading an outer surface of the corresponding other of: the first connector and the second connector to facilitate an automatic rotational movement of the locking element along the threaded outer surface and against the linear direction of the exerted force in response thereto to lock on to the one of: the first connector and the second connector.

18. The method of claim 17, further comprising turning the locking element counter to a rotational direction of the automatic rotational movement thereof to unlock the air bottle from the emergency air fill station such that the air bottle with the second connector is removable from the first connector of the emergency air fill station.

19. The method of claim 15, comprising at least one of:
the emergency air fill station being at least one of: an emergency air fill panel and a rupture containment air fill station configured to contain the air bottle within an enclosure; and
the first connector being provided directly at least one of: at a free end of a fill hose of the emergency air fill panel and on a main frame of the rupture containment air fill station.

20. The method of claim 15, further comprising maintaining an air connection between the air bottle and the emergency air fill station in a state of the first connector being locked to the second connector based on providing an air passage in each of: the first connector and the second connector.
